(19) United States
(12) Patent Application Publication
(10) Pub. No.: US 2026/0006133 A1
(43) Pub. Date: Jan. 1, 2026

(54) IMAGE PROCESSING APPARATUS AND CONTROL METHOD THEREFOR

(71) Applicant: CANON KABUSHIKI KAISHA, Tokyo (JP)

(72) Inventor: KYOSUKE NAKANO, Chiba (JP)

(21) Appl. No.: 19/243,220

(22) Filed: Jun. 19, 2025

(30) Foreign Application Priority Data
Jun. 27, 2024 (JP) 2024-103874

(51) Int. Cl. H04N 1/00

(52) U.S. Cl. CPC H04N 1/00087; H04N 1/00076; H04N 1/00413; H04N 1/00477; H04N 2201/0094

(57) ABSTRACT

An image processing apparatus displays a message based on receipt of a predetermined operation from a user and switches a mode of the image processing apparatus to a setting mode based on receipt of an operation from the user in a state in which the message is displayed, wherein the message is a message indicating that the image processing apparatus is no longer covered by a warranty.

### BACKGROUND

### Field

The present disclosure relates to an image processing apparatus and a control method therefor.

### Description of the Related Art

According to Japanese Patent Application Laid-Open No. 2002-176571, a method is discussed which enables a user to easily execute a repair mode by displaying an operation procedure of the repair mode on a screen of an electronic device.

Although it is necessary to open a repair mode to general users, it is difficult to provide a warranty for a defect in the device caused by the general users using the repair mode. Thus, switching to a setting mode such as a repair mode may result in the device being treated as not covered by the warranty.

In that case, a user may switch to the setting mode without knowing that it will void the warranty, which may lead to an unintended consequence.

### SUMMARY OF THE INVENTION

Therefore, an image processing apparatus according to the present disclosure is directed to preventing a user from switching to a setting mode without knowing that it will void its warranty.

An image processing apparatus according to the present disclosure has been made in view of the above issue. According to an aspect of the present disclosure, an image processing apparatus includes at least one memory storing instructions and at least one processor that, upon execution of the stored instructions, is configured to display a message based on receipt of a predetermined operation from a user and switch a mode of the image processing apparatus to a setting mode based on receipt of an operation from the user in a state in which the message is displayed, wherein the message is a message indicating that the image processing apparatus is no longer covered by a warranty.

Further features of the present disclosure will become apparent from the following description of exemplary embodiments with reference to the attached drawings.

### BRIEF DESCRIPTION OF THE DRAWINGS

FIG. 1 illustrates an example of a system configuration including an image processing apparatus according to an exemplary embodiment.

FIG. 2 illustrates an example of a hardware configuration of the image processing apparatus according to the exemplary embodiment.

FIG. 3 is a flowchart illustrating processing according to a first exemplary embodiment.

FIG. 4 is a flowchart illustrating processing according to a second exemplary embodiment.

FIG. 5 is a flowchart illustrating processing according to a third exemplary embodiment.

FIG. 6 is a flowchart illustrating processing according to a fourth exemplary embodiment.

FIG. 7 is a screen flow illustrating screen transition according to the first exemplary embodiment.

FIG. 8 is a screen flow illustrating screen transition according to the second exemplary embodiment.

FIG. 9 is a screen flow illustrating screen transition according to the third exemplary embodiment.

FIG. 10 is a screen flow illustrating screen transition according to the fourth exemplary embodiment.

### DESCRIPTION OF THE EMBODIMENTS

Various exemplary embodiments of the present disclosure will be described in detail below with reference to the attached drawings. It is noted that the following exemplary embodiments are not meant to limit the scope of the present disclosure as encompassed by the appended claims. Further, not all combinations of features described in the exemplary embodiments are essential for implementing the present disclosure.

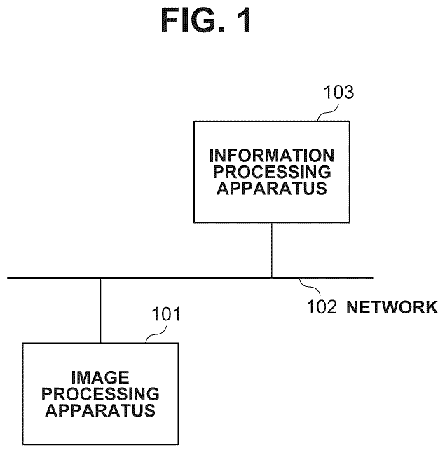

FIG. 1 is a system configuration diagram including an image processing apparatus according to the present disclosure.

An image processing apparatus 101 has an image reading function and an output (external transmission and printing) function. The image processing apparatus 101 is connected to a network 102 and can perform network communication through the network 102 with an information processing apparatus 103 also connected to the network 102.

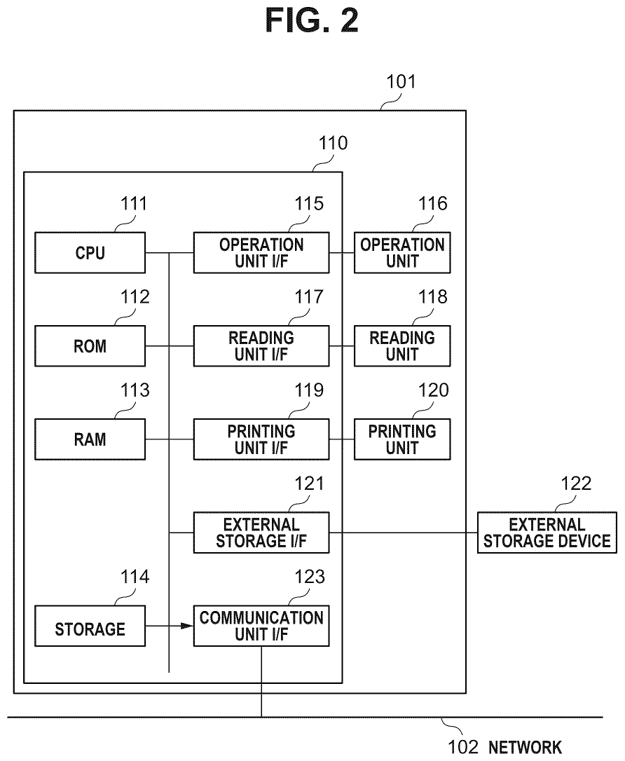

FIG. 2 is a block diagram illustrating a configuration of the image processing apparatus 101 (hereinbelow, the image processing apparatus 101 is referred to as a multifunction peripheral (MFP)).

A control unit 110 including a central processing unit (CPU) 111 controls overall operations of the MFP 101. The CPU 111 reads a control program stored in a read-only memory (ROM) 112 or a storage 114 and performs various types of control such as reading control, printing control, and communication control.

The ROM 112 stores a control program that can be executed by the CPU 111. The ROM 112 also stores a boot program, font data, and the like.

A random access memory (RAM) 113 is a main storage memory of the CPU 111 and is used as a work area and a temporary storage area for loading various control programs stored in the ROM 112 and the storage 114.

The storage 114 stores image data, print data, an address book, a shortcut, various programs, and various types of setting information. According to the present exemplary embodiment, the storage 114 is assumed to be a flash memory, but it may be configured to use an auxiliary storage device such as a solid state drive (SSD), a hard disk drive (HDD), or an embedded Multi-Media Card (eMMC) and it is not limited in the present disclosure.

In the MFP 101, one CPU 111 executes each processing illustrated in flowcharts, which are described below, using one memory (the RAM 113), but another form may be used. For example, a plurality of CPUs, RAMs, ROMs, and storages may cooperate to execute each process illustrated in the flowcharts described below. Further, hardware circuits such as an application specific integrated circuit (ASIC) and a field programmable gate array (FPGA) may be used to execute a part of the process.

An operation unit interface (I/F) 115 connects an operation unit 116 and the control unit 110. The operation unit 116 displays information to a user and detects input from the user.

A reading unit I/F 117 connects a reading unit 118 and the control unit 110. The reading unit 118 is, for example, a scanner, reads an image on a document placed on a document placement unit, and converts the image into image data such as binary data. A document is conveyed by a conveyance unit (not illustrated) and read by the reading unit 118. The image data generated by the reading unit 118 is transmitted to an external device, stored in an external storage device, or printed on a recording sheet.

A printing unit I/F 119 connects a printing unit 120 and the control unit 110. The CPU 111 transfers image data to be printed (print target image data) to the printing unit 120 via the printing unit I/F 119. The printing unit 120 is, for example, a printer and prints an image on a recording sheet fed from a sheet feeding cassette (not illustrated) using toner supplied from a cartridge (not illustrated).

An external storage I/F 121 connects an external storage device 122 and the control unit 110. The CPU 111 stores image data in the external storage device 122 via the external storage I/F 121. According to the present exemplary embodiment, the external storage I/F 121 is assumed to be a universal serial bus (USB) interface, and the external storage device 122 is assumed to be a USB memory, but an external storage device such as a secure digital (SD) card may also be used.

The control unit 110 is connected to the network 102 by a communication unit I/F 123.

The communication unit I/F 123 performs network communication via the network 102 with an external device such as the information processing apparatus 103 also connected to the network 102.

A first exemplary embodiment of the present disclosure will now be described. The first exemplary embodiment is a method for solving the above-described issues.

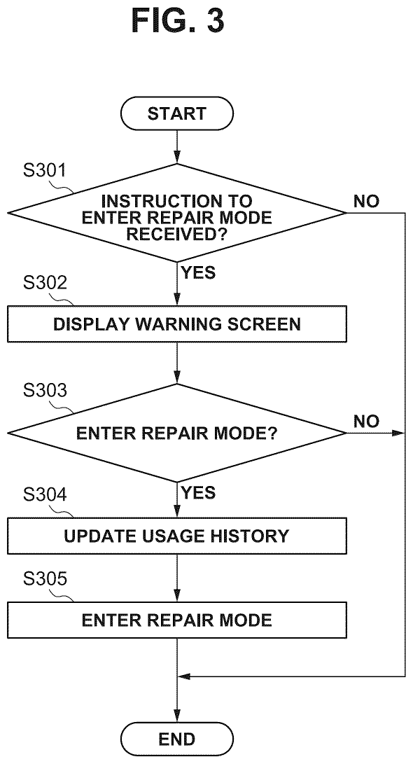

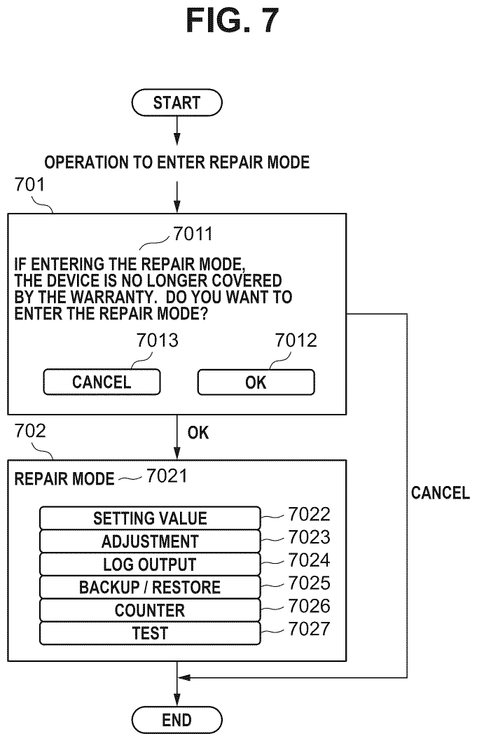

FIG. 3 is a flowchart illustrating processing in a case where an instruction to enter a repair mode is received. The processing illustrated in the flowchart in FIG. 3 is performed by the CPU 111 reading a program stored in the ROM 112 or the storage 114 into the RAM 113 and executing it. The processing is described with reference to a screen in a screen flow illustrated in FIG. 7 as appropriate.

In step S301, the CPU 111 determines whether an instruction to enter the repair mode (setting mode) is received. If it is YES in step S301, the processing proceeds to step S302, whereas if it is NO in step S301, the processing terminates.

There is no particular limitation on the method for entering the repair mode, but three basic implementation methods, a first method, a second method, and a third method will be described.

The first method is a method in which a general user enters the repair mode via a mode for using a part of functions of the repair mode (hereinbelow, referred to as a special mode). If a general user has trouble with a defect of an MFP, the general user inquires of a person in charge of support of a company that has sold the MFP, and the person in charge of support guides the general user to an appropriate execution method, so that the general user can know how to execute the special mode and execute a part of the functions of the repair mode. As a specific procedure, the general user enters the special mode, specifies a corresponding item in the repair mode by inputting an identification (ID) (hereinbelow, referred to as an item ID) associated therewith, and can execute the corresponding item in the repair mode. According to the present exemplary embodiment, no distinction is made, in the present method via the special mode, between entering the repair mode by inputting the item ID and executing the corresponding item in the repair mode by inputting the item ID without entering the repair mode. Particularly in the former case, the apparatus may be configured not to enter the normal repair mode but to enter a repair mode that restricts display of an item that the company wants to keep secret from the general user and displays other items (hereinbelow, referred to as a restricted repair mode). Hereinbelow, the term “repair mode” used in the present disclosure is understood to include the restricted repair mode unless otherwise specified, but if a distinction is necessary, the restricted repair mode and the normal repair mode (hereinbelow, referred to as an unrestricted repair mode) are referred to separately.

The second method is a method for entering the repair mode by a special operation that is not normally performed by a general user. The second method refers to a method for entering the repair mode by executing a specific key operation, touch operation, or a combination of these operations on the operation unit I/F 115. As a condition for executing these operations, a specific timing or status, or execution by a specific user may be added.

The third method is a method for entering the repair mode via a mode that is used by a general user in a normal use (hereinbelow, referred to as a user mode). The third method refers to a method for displaying, in the user mode, the repair mode as one icon on a HOME screen or as one function on a menu screen that displays executable functions in a list.

In step S302, the CPU 111 displays a warning screen 701, which is a confirmation screen, on the operation unit I/F 115 and receives a selection as to whether to enter the repair mode. A message 7011 on the warning screen 701 warns the user that the MFP 101 will not be covered by the warranty from the company if it enters the repair mode and inquires of the user whether to enter the repair mode while accepting that the MFP 101 is not covered by the warranty. Further, the CPU 111 displays a button 7012 for entering the repair mode and a button 7013 for not entering the repair mode on the warning screen 701.

In other words, if a predetermined operation is received from the user as described above, a screen including a message indicating that the MFP 101 is no longer covered by the warranty is displayed. The message may be displayed in a status bar instead of on the warning screen 701.

In step S303, the CPU 111 determines whether the button 7012 for entering the repair mode is selected on the warning screen 701 displayed on the operation unit I/F 115. If it is YES in step S303, the processing proceeds to step S304, whereas if it is NO in step S303, the processing terminates.

In other words, if an operation is received from the user in a state in which the message is displayed as described above, the mode of the MFP 101 is switched to the setting mode.

In step S304, the CPU 111 reads information regarding usage history of the repair mode (hereinbelow, referred to as usage history information) from a non-volatile area of the RAM 113, rewrites and stores it. Although there is no particular limitation on a configuration of the usage history information, three basic configurations, a first configuration, a second configuration, and a third configuration of the usage history information are described.

The first configuration of the usage history information includes information indicating whether the repair mode is already used. In step S304, the usage history information is rewritten from a value indicating unused to a value indicating used. If the value already indicates used, the value remains unchanged. It is assumed that an initial value is a value indicating unused. The value indicating used may be associated with the number of times the repair mode is used.

The second configuration of the usage history information includes date information about when the repair mode is entered and user information about a user who entered the repair mode. Regarding the date information, processing for acquiring current date information is executed in the processing in step S304, and the acquired date information is stored. Regarding the user information, in a case where user login is managed at the time of using the MFP 101, information about the user who currently operates the MFP 101 may be acquired and stored in the processing in step S304.

The third configuration of the usage history information includes a list that can store the date information as one element therein, and the date information at the time of execution is written in an unused area of the list every time the processing in step S304 is executed. Thus, the number of elements including the date information in the list is equal to the number of times the repair mode is entered. Further, the list may be formed in which the date information is associated with the user information as one element.

In this way, the mode of the image processing apparatus 101 is switched to the setting mode, and thus the MFP 101 is no longer covered by the warranty. Specifically, information indicating that the MFP 101 is no longer covered by the warranty is stored. The information may be stored in the storage 114, a cloud server, or the like.

In step S305, the CPU 111 enters the repair mode and displays a repair mode screen 702 on the operation unit I/F 115. The repair mode screen 702 includes a display 7021 indicating that the MFP 101 is currently in the repair mode and items 7022 to 7027 of the repair mode. The items do not have to be limited to those classified as the items 7022 to 7027. Further, the repair mode screen 702 may be configured so that a function is executed by selecting one of the items 7022 to 7027 or may be configured to shift to a screen that displays a plurality of items related to the selected item and to cause the user to select an item again.

The item 7022 is related to a setting value and is an item for checking a status of the MFP 101 main body, version information, parts information, a setting value related to the function of the repair mode, and the like by displaying them on the operation unit I/F 115. Some of the information may be not only displayed but also edited or initialized. In other words, by switching to the setting mode in this way, the user can check the parts information about the MFP 101.

The item 7023 is related to adjustment and is an item for executing adjustment on the MFP 101 main body or for performing a setting for executing adjustment. Specifically, there are an adjustment item that changes the corresponding setting value according to an actual operation of the reading unit 118 or the printing unit 120 in a case where an abnormality occurs in a result of image processing and an adjustment item that updates defective firmware to another firmware, but the adjustment items do not have to be limited to these. In other words, by switching to the setting mode in this way, the user can update the firmware of the MFP 101.

The item 7024 is related to log output and is an item for outputting an operation history, a past adjustment result, counter information about the item 7026, which is described below, and the like as a log in addition to the item in the item 7022. A method for outputting a log may be a general method, and for example, the log may be output to and stored in the external storage device 122 mounted on the MFP 101, but the method is not limited to this.

The item 7025 is related to backup and restore, and all data that are output targets of the log described in the item 7024 are converted into a file and exported, or the above-described file is imported from the outside and reflected to the MFP 101. A method for export and import may be a general method, and for example, a file may be exported to or imported from the external storage device 122 mounted on the MFP 101, but the method is not limited to this.

The item 7026 is related to a counter and is an item for displaying and checking the number of times a specific operation is performed, the number of times a specific job or movement is executed, the number of times a specific status or an execution result is reached, and the like on the operation unit I/F 115.

The item 7027 is related to a test and is an item for displaying a confirmation procedure for a specific repair and simplifying a repair work performed by the user.

First, the display of the warning screen 701 in step S302 does not have to be performed every time it is determined in step S301 that the instruction to enter the repair mode is received. For example, the warning screen 701 may be displayed only if it can be determined that the processing in step S301 is executed for the first time or may be displayed only if it can be determined that the repair mode is unused or the number of times the repair mode is used is a certain number or less by referring to the usage history information to be updated in step S304. Further, the warning screen 701 may be displayed only if a condition that can be derived from the date information or the user information stored in the usage history information is met.

In other words, in a case where a predetermined operation is received from a user in a state in which the MFP 101 is not covered by the warranty, the mode of the MFP 101 is switched to the setting mode without displaying a message indicating that the MFP 101 is no longer covered by the warranty.

Next, the display of the warning screen 701 in step S302 and the update of the usage history information in step S304 may be performed at timings different from those described in steps S302 and S304. Specifically, if the instruction to enter the repair mode is received in step S301, the processing proceeds to step S305 to enter the repair mode, and the warning screen described below is displayed after entering the repair mode. The warning screen displays a message indicating that the MFP 101 will not be covered by the warranty from the company if the repair mode is continued and inquiring of the user whether to continue the repair mode while accepting that the MFP 101 is not covered by the warranty, and displays a continue button and a cancel button. If it is determined that the continue button is selected, in step S304, the usage history is updated, and if not, the processing terminates.

A method for checking the usage history information rewritten in step S304 is described. A setting for checking the usage history information in the user mode, the repair mode, or the special mode may be provided and checked on the operation unit I/F 115. The usage history information may be printed as a report by the printing unit 120 in the user mode, the repair mode, or the special mode. Further, the usage history information may be transmitted to the information processing apparatus 103 connected to the MFP 101 via the network 102 periodically or a timing at which the usage history information is rewritten.

Finally, the functions executable by the MFP 101 may be switched according to the usage history information. For example, in a case where it is determined that the repair mode has already been used or has been used for a certain number of times or more by referring to the usage history information, control may be performed so that a function of contracting for support such as repair with the company or the store that sold the MFP 101 cannot be executed. Also, in a case where the condition that can be derived from the date information or the user information stored in the usage history information is met, control may be performed so that the function cannot be executed. Further, in a case where the condition that can be derived by combining the usage history information and the information related to the status and the counter acquired from the MFP 101 is met, control may be performed so that the function cannot be executed.

A notification may be transmitted to an administrator user of the MFP 101 in response to switching the mode of the MFP 101 to the setting mode. In that case, an electronic mail (e-mail) including a message indicating that the mode is switched to the setting mode is transmitted to an e-mail address registered as account information about the administrator user in the MFP 101. A timing for transmitting a notification to the administrator user may be not a timing when switching to the setting mode but a timing when the warning screen 701 is displayed. In other words, the message is displayed, and thus the notification is transmitted to the administrator user of the MFP 101.

A second exemplary embodiment of the present disclosure is described. The second exemplary embodiment is a method for solving the above-described issues as in the first exemplary embodiment and is characterized by displaying the warning screen and managing the usage history information for each item of the repair mode.

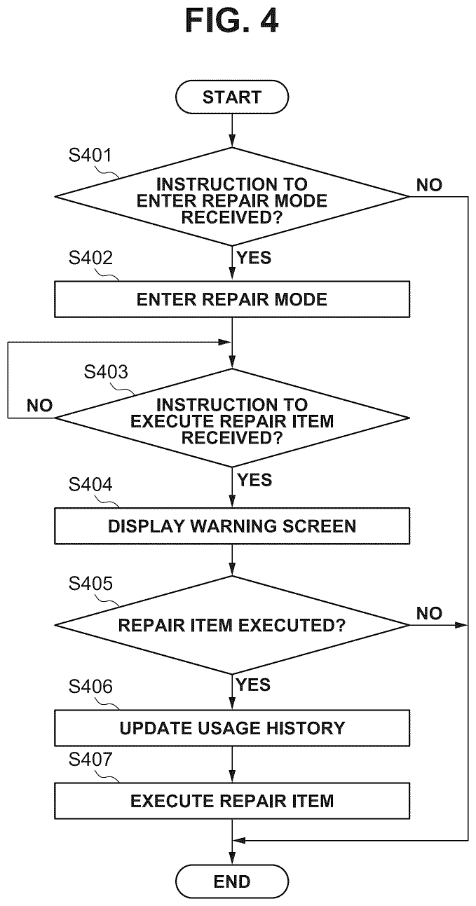

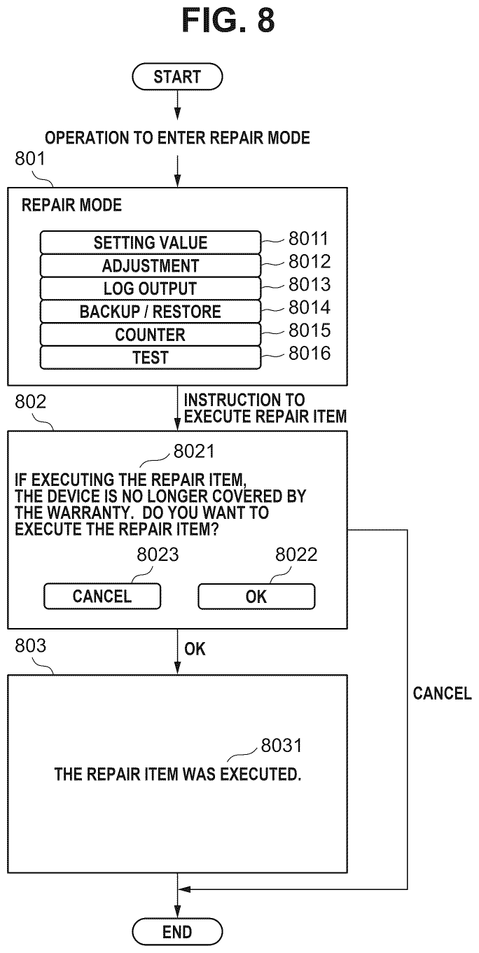

FIG. 4 is a flowchart illustrating processing in a case where an instruction to enter the repair mode is received. The processing illustrated in the flowchart in FIG. 4 is performed by the CPU 111 reading a program stored in the ROM 112 or the storage 114 into the RAM 113 and executing it. The processing is described with reference to a screen in a screen flow illustrated in FIG. 8 as appropriate.

In step S401, the CPU 111 determines whether an instruction to enter the repair mode is received. If it is YES in step S401, the processing proceeds to step S402, whereas if it is NO in step S401, the processing terminates. There is no particular limitation on the method for entering the repair mode, but the first, second, and third methods described in step S301 are the basic implementation methods.

In step S402, the CPU 111 enters the repair mode and displays a repair mode screen 801 on the operation unit I/F 115. The repair mode screen 801 is equivalent to the repair mode screen 702, and items 8011 to 8016 are equivalent to the items 7022 to 7027, so that a description of the repair mode screen 801 is omitted.

In step S403, the CPU 111 determines whether any of the items 8011 to 8016 or an item, which is displayed if any of the items 8011 to 8016 is selected, is selected. If it is YES in step S403, the processing proceeds to step S404, whereas if it is NO in step S403, the processing proceeds again to step S403.

In step S404, the CPU 111 displays a warning screen 802 on the operation unit I/F 115 and receives a selection as to whether to execute the item of the repair mode. A message 8021 on the warning screen 802 warns the user that the MFP 101 will not be covered by the warranty from the company if the item of the repair mode is executed and inquires of the user whether to execute the item of the repair mode while accepting that the MFP 101 is not covered by the warranty. Further, the CPU 111 displays a button 8022 for executing the item of the repair mode and a button 8023 for not executing the item of the repair mode on the warning screen 802.

In step S405, the CPU 111 determines whether the button 8022 for executing the item of the repair mode on the warning screen 802 displayed on the operation unit I/F 115 is selected. If it is YES in step S405, the processing proceeds to step S406, whereas if it is NO in step S405, the processing terminates.

In step S406, the CPU 111 reads the usage history information from the non-volatile area of the RAM 113, rewrites, and stores it. There is no particular limitation on the configuration of the usage history information according to the second exemplary embodiment, but three basic configurations, a fourth configuration, a fifth configuration, and a sixth configuration of the usage history information are described.

The fourth configuration of the usage history information includes the item ID of the item instructed to be executed in step S403. Any information associated with the item ID may be used, such as an item name. In step S406, the CPU 111 acquires the item ID of the item instructed to be executed in step S403 and rewrites the initial value to a value indicating the item ID. If the value already indicates the item ID other than the initial value, there is no need to rewrite the value in particular. It is assumed that the initial value is a value that does not match any item ID.

The fifth configuration of the usage history information includes a list that stores information indicating whether the repair mode is already used for each of the items of the repair mode. In step S406, the CPU 111 rewrites the information indicating whether the repair mode corresponding to the item instructed to be executed in step S403 is already used from a value indicating unused to a value indicating used. If the value already indicates used, the value remains unchanged. It is assumed that the initial value of the information indicating whether the repair mode corresponding to each item is already used is a value indicating unused. The value indicating used may be associated with the number of times the corresponding item in the repair mode has been executed. Further, a list may be formed in which the date information and the user information are included as one element in addition to the information indicating whether the repair mode is already used for each item.

The sixth configuration of the usage history information includes a list that can store the date information and the item ID as one element in association with each other, and the date information at the time of execution and the item ID instructed to be executed in step S403 are written in an unused area in the list every time the processing in step S406 is executed. Thus, the number of elements including the date information and the item ID in the list is equal to the number of times the repair mode is entered. Further, the list may be formed in which the date information and the item ID are associated with the user information as one element.

In step S407, the CPU 111 executes the item instructed to be executed in step S403. If the execution is completed, a report screen 803 may be displayed. The report screen 803 displays a message 8031 reporting that the execution of the item of the repair mode is completed.

First, the display of the warning screen 802 in step S404 does not have to be performed every time it is determined in step S403 that the instruction to execute the item of the repair mode is received. For example, the warning screen 802 may be displayed only if it can be determined that the processing in step S403 is executed for the first time. Further, the warning screen 802 may be displayed only if it can be determined that the corresponding item in the repair mode is unused, the number of times the corresponding item has been used is a certain number or less, or a total number of times of use associated with a plurality of items is a certain number or less by referring to the usage history information updating in step S406. Furthermore, the warning screen 802 may be displayed only if a condition that can be derived from the date information or the user information stored in the usage history information is met.

Next, the display of the warning screen 802 in step S404 and the update of the usage history information in step S406 may be performed at timings different from those described in steps S404 and S406. Specifically, if the instruction to execute the item of the repair mode is received in step S403, the processing proceeds to step S406 to update the usage history information. Then, the processing proceeds to step S407 to execute the item of the repair mode, and the warning screen described below is displayed after the execution. The warning screen displays a message indicating that the MFP 101 will not be covered by the warranty from the company because the item of the repair mode is executed.

A method for checking the usage history information rewritten in step S406 is the same as that according to the first exemplary embodiment, and thus a description thereof is omitted.

In addition, the functions executable by the MFP 101 may be switched according to the usage history information. For example, in a case where it is determined that the corresponding item in the repair mode is already used or is used for a certain number of times or more, or the total number of times of use associated with a plurality of items is a certain number or more by referring to the usage history information, control may be performed so that a specific function cannot be executed. Also, in a case where the condition that can be derived from the date information or the user information stored in the usage history information is met, control may be performed so that the function cannot be executed. Further, in a case where the condition that can be derived by combining the usage history information and the information related to the status and the counter acquired from the MFP 101 is met, control may be performed so that the function cannot be executed.

Finally, according to the second exemplary embodiment, the item of the repair mode is executed after entering the repair mode, but the item of the repair mode may be executed in the user mode or the special mode without entering the repair mode. For example, the items of the repair mode may be displayed on the menu in the user mode in addition to the items of the user mode and executed, or the item ID of the corresponding repair mode may be input and executed in the special mode.

A third exemplary embodiment of the present disclosure is described. The third exemplary embodiment is a method for solving the above-described issues as in the first exemplary embodiment and is characterized in that the MFP that manages user login switches the display of the warning screen at the time of entering the repair mode and an approval flow for entering the repair mode depending on a user.

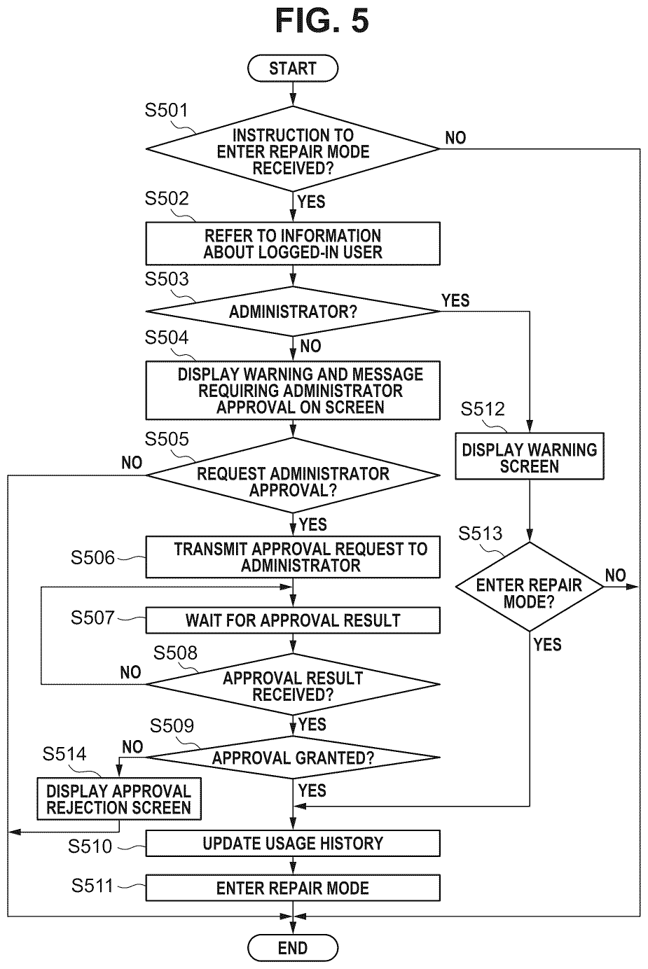

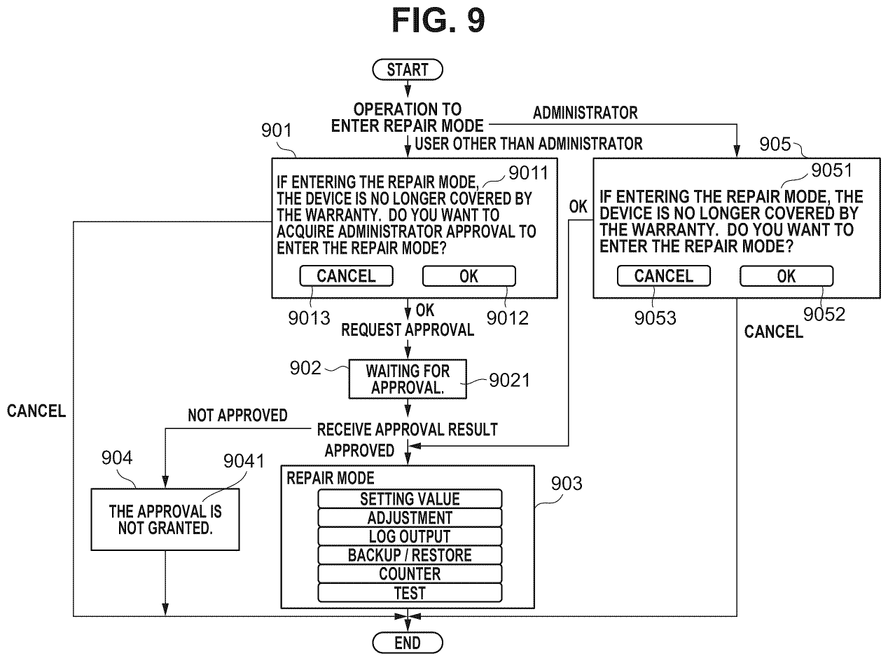

FIG. 5 is a flowchart illustrating processing in a case where an instruction to enter the repair mode is received. The processing illustrated in the flowchart in FIG. 5 is performed by the CPU 111 reading a program stored in the ROM 112 or the storage 114 into the RAM 113 and executing it. The processing is described with reference to a screen in a screen flow illustrated in FIG. 9 as appropriate.

In step S501, the CPU 111 determines whether an instruction to enter the repair mode is received. If it is YES in step S501, the processing proceeds to step S502, whereas if it is NO in step S501, the processing terminates. There is no particular limitation on the method for entering the repair mode, but the first, second, and third methods described in step S301 are the basic implementation methods.

In step S502, the CPU 111 refers to information of the user who has logged in to the MFP 101. It is sufficient to be able to refer to information that enables determination of whether the currently logged-in user is an administrator user or a general user. In addition, it may be possible to refer to other information related to the user, such as an ID for identifying the user, a department to which the user belongs, and position and authority of the user. Hereinbelow, unless otherwise specified, the third exemplary embodiment is described on the assumption that a configuration is adopted in which information that enables determination of whether a currently logged-in user is an administrator user or a general user is referred to.

In step S503, in a case where the CPU 111 determines that the currently logged-in user is the general user based on the user information referred to in step S502 (NO in step S503), the processing proceeds to step S504, whereas if not (YES in step S503), the processing proceeds to step S512. According to the third exemplary embodiment, a condition is whether the user is the general user. However, if there is other information referred to in step S502, such as the ID for identifying the user, the department to which the user belongs, and the position and authority of the user, the condition may be replaced with a condition that can be derived from the above-described information.

In step S504, the CPU 111 displays a warning screen 901 on the operation unit I/F 115 and receives a selection as to whether to enter the repair mode. A message 9011 on the warning screen 901 warns the user that the MFP 101 will not be covered by the warranty from the company if it enters the repair mode and inquires of the user whether to request approval from the administrator user for voiding the warranty to enter the repair mode. Further, the CPU 111 displays a button 9012 for requesting approval to enter the repair mode and a button 9013 for not entering the repair mode on the warning screen 901.

In step S505, the CPU 111 determines whether the button 9012 for requesting approval to enter the repair mode on the warning screen 901 displayed on the operation unit I/F 115 is selected. If it is YES in step S505, the processing proceeds to step S506, whereas if it is NO in step S505, the processing terminates.

In step S506, the CPU 111 transmits a request for approval to the administrator user. A method for requesting approval from the administrator user is not particularly limited and may be a general method. For example, it is sufficient that an e-mail address included in information associated with the administrator user is read out, and an e-mail is transmitted from the MFP 101 to the e-mail address of the administrator user. It is sufficient that a text described in the e-mail to be transmitted includes information about the user who requests the approval, a message that approval for entering the repair mode is requested, a warning that the MFP 101 will not be covered by the warranty from the company if it enters the repair mode, and the method for approval. The method for approval is not limited, but for example, the administrator user replies to the received e-mail by transmitting an e-mail stating whether to approve the request to the MFP 101, and the MFP 101 can determine an approval result by analyzing the message of the received e-mail. According to the third exemplary embodiment, an approval request destination is the administrator user, but it is not necessary to be limited to the administrator user. For example, a function may be provided to individually register a user as an approval request destination in a case where an operation to enter the repair mode is performed, the user is registered in advance, and approval may be requested to the registered user, and approval may be requested for a user who meets a specific condition that can be derived from the user information.

In step S507, the CPU 111 displays an approval waiting screen 902 on the operation unit I/F 115 and waits for reception of the approval result. The approval waiting screen 902 displays a message 9021 indicating that it is waiting for approval. According to the third exemplary embodiment, it is configured to continue waiting for reception of the approval result, but the present disclosure is not limited to this configuration. For example, in a case where the approval result cannot be received after waiting for a certain period of time, the processing may terminate. Further, a button enabling the user to shift the screen to another screen while waiting for the approval result may be provided on the approval waiting screen 902, and even if the screen is shifted to the other screen, the screen may be shifted to a repair mode screen 903 if it is determined as approved.

In step S508, the CPU 111 determines whether the approval result is received. If it is YES in step $508, the processing proceeds to step S509, whereas if it is NO in step S508, the processing returns to step $507.

In step S509, the CPU 111 refers to the received approval result and determines whether approval is granted. If it is YES in step S509, the processing proceeds to step S510, whereas if it is NO in step S509, the processing proceeds to step S514.

Processing in steps S510 and S511 is the same as that in steps S304 and S305 according to the first exemplary embodiment, and thus the description thereof is omitted. However, the usage history information updated in step S510 may be configured to manage any one of the first to third configurations of the usage history information described in the first exemplary embodiment for each user in addition to the first to third configurations.

In step S512, the CPU 111 displays a warning screen 905 on the operation unit I/F 115 and receives a selection as to whether to enter the repair mode. A message 9051 on the warning screen 905 warns the user that the MFP 101 will not be covered by the warranty from the company if it enters the repair mode and inquires of the user whether to enter the repair mode while accepting that the MFP 101 is not covered by the warranty. Further, the CPU 111 displays a button 9052 for entering the repair mode and a button 9053 for not entering the repair mode on the warning screen 905.

In step S513, the CPU 111 determines whether the button 9052 for entering the repair mode on the warning screen 905 displayed on the operation unit I/F 115 is selected. If it is YES in step S513, the processing proceeds to step S510, whereas if it is NO in step S513, the processing terminates.

In step S514, the CPU 111 displays an approval rejection screen 904 indicating that entering the repair mode is not approved on the operation unit I/F 115. The approval rejection screen 904 displays a message 9041 indicating that approval is not granted.

First, the warning screen 901 in step S504 and the warning screen 905 in step S512 do not have to be displayed every time it is determined in step S501 that the instruction to enter the repair mode is received. For example, the warning screens 901 and 905 may be displayed only if it can be determined that the processing in step S501 is executed for the first time or may be displayed only if it can be determined that the repair mode is unused or the number of times the repair mode has been used is a certain number of times or less by referring to the usage history information updated in step S510. Further, the warning screens 901 and 905 may be displayed only if a condition that can be derived from the date information or the user information stored in the usage history information is met. A condition related to frequency of display may be determined based on the user information referred to in step S502, and the warning screens 901 and 905 may be displayed only for the first time for each user, for example.

According to the third exemplary embodiment, as in the first exemplary embodiment, the warning screen is displayed in a case where an operation to enter the repair mode is received, and the usage history information is updated in a case where the agreement about the content of the warning can be gotten or the content of the warning can be approved by the administrator user after the agreement. The third exemplary embodiment may adopt a configuration accompanying execution of the item of the repair mode as in the second exemplary embodiment. Specifically, in a case where an operation to execute the item of the repair mode is received, and if the warning screen is displayed and the agreement about the content of the warning can be gotten or the content of the warning can be approved by the administrator user after the agreement, the usage history information may be updated.

A fourth exemplary embodiment of the present disclosure is described. The fourth exemplary embodiment is a method for solving the above-described issues as in the first exemplary embodiment and is characterized in that each of the display of the warning screen in entering the repair mode and the update of the usage history information is switched depending on whether an operating user is a person in charge of repairing. According to the first to third exemplary embodiments, it is described that the warning is displayed and the usage history information is updated for any user entering of the repair mode or executing of the item of the repair mode. On the other hand, if the methods according to the first to third exemplary embodiments are applied to a case in which the person in charge of repairing who is originally designated to use the repair mode uses the repair mode, the warning is displayed and the usage history information is updated. This means that even though it may still be covered by the warranty from the company after the person in charge of repairing uses the repair mode or executes the item of the repair mode, unnecessary warning is displayed and the usage history information is updated inappropriately. The fourth exemplary embodiment is a method for solving these issues.

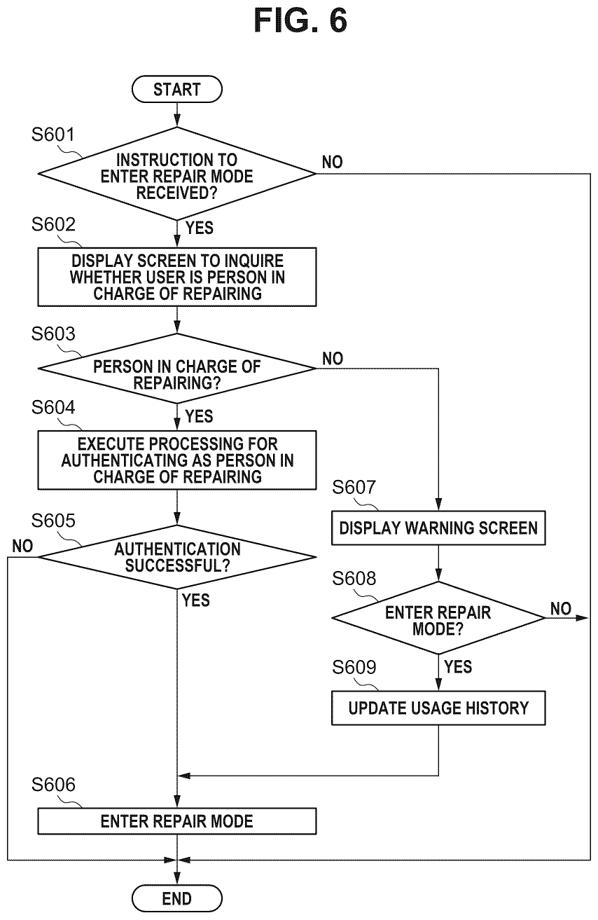

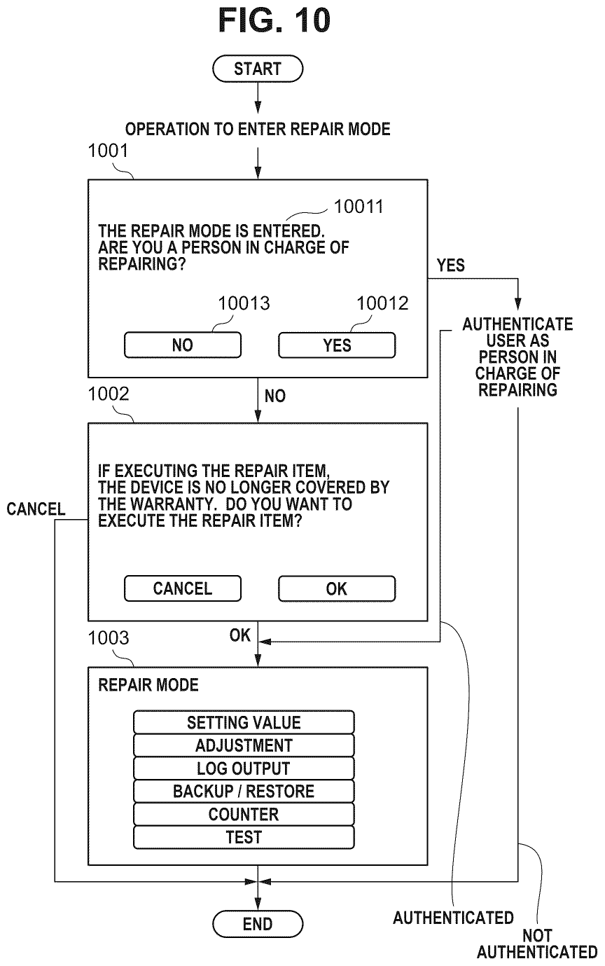

FIG. 6 is a flowchart illustrating processing in a case where an instruction to enter the repair mode is received. The processing illustrated in the flowchart in FIG. 6 is performed by the CPU 111 reading a program stored in the ROM 112 or the storage 114 into the RAM 113 and executing it. The processing is described with reference to a screen in a screen flow illustrated in FIG. 10 as appropriate.

In step S601, the CPU 111 determines whether an instruction to enter the repair mode is received. If it is YES in step S601, the processing proceeds to step S602, whereas if it is NO in step S601, the processing terminates. There is no particular limitation on the method for entering the repair mode, but the first, second, and third methods described in step S301 are the basic implementation methods.

In step S602, the CPU 111 displays an inquiry screen 1001 to inquire whether an operating user is the person in charge of repairing on the operation unit I/F 115. The inquiry screen 1001 displays a message 10011 inquiring whether the operating user is the person in charge of repairing. Further, the inquiry screen 1001 displays a button 10012 for replying that the user is the person in charge of repairing and a button 10013 for replying that the user is a user other than the person in charge of repairing.

In step S603, the CPU 111 determines whether the button 10012 for replying that the user is the person in charge of repairing, which is described in step S602, is selected. If it is YES in step S603, the processing proceeds to step S604, whereas if it is NO in step S603, the processing proceeds to step S607.

In step S604, the CPU 111 executes processing for authenticating that the user currently using the MFP 101 is the person in charge of repairing. An authentication method is not particularly limited and may be a general method. For example, the person in charge of repairing is requested to input an authentication code which the person is informed of in advance, and if the input code is the above-described authentication code, the user can be authenticated as the person in charge of repairing.

In step S605, the CPU 111 determines whether authentication processing in step S604 is successful. If it is YES in step S605, the processing proceeds to step S606, whereas if it is NO in step S605, the processing terminates.

Processing in step S606 is the same as that in step S305 according to the first exemplary embodiment, and thus the description thereof is omitted.

Processes in steps S607 to S609 are the same as those in steps S302 to S304 respectively, and thus the description thereof is omitted. A warning screen 1002 corresponds to the warning screen 701 according to the first exemplary embodiment, and a repair mode screen 1003 corresponds to the repair mode screen 702 according to the first exemplary embodiment.

According to the fourth exemplary embodiment, if an operation to enter the repair mode is received, the screen inquiring whether the user is the person in charge of repairing is displayed, and if the user answers that the user is the person in charge of repairing, authentication that the user is the person in charge of repairing is requested.

If the user does not answer that the user is the person in charge of repairing, the warning screen is displayed as in the first exemplary embodiment, and the usage history information is updated in a case where the agreement about the content of the warning is gotten. The processing may be executed not if an operation to enter the repair mode is received but if an operation to execute the item of the repair mode is received.

The above-described processing can prevent a user from switching to the setting mode without knowing that the warranty will be voided.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-103874, filed Jun. 27, 2024, which is hereby incorporated by reference herein in its entirety.

What is claimed is:

1. An image processing apparatus comprising:
at least one memory storing instructions; and
at least one processor that, upon execution of the stored instructions, is configured to:
display a message based on receipt of a predetermined operation from a user; and
switch a mode of the image processing apparatus to a setting mode based on receipt of an operation from the user in a state in which the message is displayed,
wherein the message is a message indicating that the image processing apparatus is no longer covered by a warranty.

2. The image processing apparatus according to claim 1,
wherein the at least one processor is further configured to:
display the message on a confirmation screen based on receipt of the predetermined operation from the user, and
enable an operation to make a selection whether to switch to the setting mode to be performed on the confirmation screen.

3. The image processing apparatus according to claim 1, wherein the at least one processor is further configured to enable updating firmware of the image processing apparatus by switching to the setting mode.

4. The image processing apparatus according to claim 1, wherein the at least one processor is further configured to enable checking parts information of the image processing apparatus by switching to the setting mode.

5. The image processing apparatus according to claim 1, wherein, if the mode of the image processing apparatus is switched to the setting mode, the image processing apparatus is no longer covered by the warranty.

6. The image processing apparatus according to claim 5, wherein, in a case where the predetermined operation is received from the user in a state in which the image processing apparatus is not covered by the warranty, the message is not displayed and mode of the image processing apparatus is switched to the setting mode.

7. The image processing apparatus according to claim 1, the at least one processor is further configured to transmit a notification to an administrator user of the image processing apparatus if the mode of the image processing apparatus is switched to the setting mode.

8. The image processing apparatus according to claim 1, the at least one processor is further configured to transmit a notification to an administrator user of the image processing apparatus if the message is displayed.

9. A method for controlling an image processing apparatus, the method comprising:
displaying a message based on receipt of a predetermined operation from a user; and
switching a mode of the image processing apparatus to a setting mode based on receipt of an operation from the user in a state in which the message is displayed,
wherein the message is a message indicating that the image processing apparatus is no longer covered by a warranty.

10. The method according to claim 9,
wherein the message is displayed on a confirmation screen based on receipt of the predetermined operation from the user, and
wherein an operation to make a selection whether to switch to the setting mode can be performed on the confirmation screen.

11. The method according to claim 9, wherein firmware of the image processing apparatus can be updated by switching to the setting mode.

12. The method according to claim 9, wherein parts information of the image processing apparatus can be checked by switching to the setting mode.

13. The method according to claim 9, wherein, if the mode of the image processing apparatus is switched to the setting mode, the image processing apparatus is no longer covered by the warranty.

14. The method according to claim 13, wherein, in a case where the predetermined operation is received from the user in a state in which the image processing apparatus is not covered by the warranty, the message is not displayed and the mode of the image processing apparatus is switched to the setting mode.

15. The method according to claim 9, further comprising transmitting a notification to an administrator user of the image processing apparatus if the mode of the image processing apparatus is switched to the setting mode.

16. The method according to claim 9, further comprising transmitting a notification to an administrator user of the image processing apparatus if the message is displayed.
